(19) United States
(12) Patent Application Publication
(10) Pub. No.: US 2024/0349696 A1
(43) Pub. Date: Oct. 24, 2024

(54) PET NAIL CLIPPER AND METHODS

(71) Applicants: William Nathan BRUNNER, Middleton, WI (US); Gregory VAN EYK, Middleton, WI (US); Spectrum Brands, Inc., Middleton, WI (US)

(72) Inventors: Jewel Cary, Middleton, WI (US); William Nathan Brunner, Middleton, WI (US); Christopher Robert Stoll, Middleton, WI (US); Gregory Van Eyk, Middleton, WI (US)

(73) Assignee: Spectrum Brands, Inc., Middleton, WI (US)

(21) Appl. No.: 18/684,517

(22) PCT Filed: Aug. 16, 2022
(86) PCT No.: PCT/US22/40491

§ 371 Date: Feb. 16, 2024

Related U.S. Application Data
(60) Provisional application No. 63/234,433, filed on Aug. 18, 2021.

(51) Int. Cl. A01K 13/00; A45D 29/02

(52) U.S. Cl. CPC A01K 13/00; A45D 29/02

(57) ABSTRACT

A pet nail clipper includes a cutter with a first blade having a first v-shaped cutting edge; and a second blade, opposed to the first blade, having a second v-shaped cutting edge. The first v-shaped cutting edge and second v-shaped cutting edge are positioned relative to each other to form a hole to receive a nail. A first arm is secured to the first blade, and a second arm is secured to the second blade. The clipper can include lighting, a transparent back stop, and an on-board medicinal agent.

### CROSS-REFERENCE TO RELATED APPLICATIONS

This application is being filed on Aug. 16, 2022, as a PCT International application and claims priority to and the benefit of U.S. Provisional Patent Application No. 63/234,433 filed Aug. 18, 2021, the disclosure of which is incorporated by reference herein in its entirety. To the extent appropriate a claim for priority is made to the above referenced application.

### TECHNICAL FIELD

This disclosure relates grooming tools for animals. In particular, this disclosure relates to a claw or nail clipper for animals kept as pets, such as dogs and cats.

### BACKGROUND

Many households include animals as pets. Some pets, such as dogs and cats, have claws or toenails. Claws or toenails can damage upholstery or flooring in a house, and can also lead to injury (scratches) of people or other animals.

Permanent declawing can be harmful to pets and expensive. Many pet owners look for alternatives to declawing. One such alternative is trimming/cutting the nails. However, many animals are resistant to having their nails cut.

Improvements are desirable.

### SUMMARY

A pet nail clipper is provided that improves the prior art.

In one aspect, a pet nail clipper is provided comprising: (a) a cutter including a first blade having a first v-shaped cutting edge; a second blade, opposed to the first blade, having a second v-shaped cutting edge; the first v-shaped cutting edge and second v-shaped cutting edge being positioned relative to each other to form a hole to receive a nail; (b) a first arm secured to the first blade; and (c) a second arm secured to the second blade.

In an example embodiment, the nail clipper further comprises a light source positioned to project light onto the cutter.

In one or more embodiments, the light source is positioned to project light from the first arm onto the cutter.

In example embodiments, the light source is an extended light pipe positioned adjacent to the first blade.

In some implementations, the first arm includes a handle section and a blade holding section; and the light pipe is secured to the blade holding section.

For some arrangements, the blade holding section includes a pair of angled members forming a chin on opposite sides of the first blade; and the light pipe secured to the chin on the opposite sides of the first blade.

In some examples, the light source is energized by an electronic charge port.

In some examples, the light source is energized by a power source held within one of the first arm or second arm.

In one or more embodiments, a transparent nail backstop is adjustably positioned relative to the cutter.

A rotatable dial may be secured to one of the first arm or second arm and constructed and arranged to move the backstop axially inward or outward.

In some examples, the rotatable dial has an outer knurled surface.

In many embodiments, there further may include an on-board medicinal agent.

In examples, the second arm includes a reservoir holding the medicinal agent.

Example embodiments include the second arm having a movable cover to expose the medicinal agent.

In some implementations, the movable cover is a flip cap pivotably attached to a remaining part of the second arm.

The medicinal agent can be a clotting agent, in one or more embodiments.

In some examples, the medicinal agent is a gelatinous pad.

In another aspect, a method of trimming toenails of a pet is provided. The method includes positioning a toenail into a hole formed by opposing first and second blades having v-shaped cutting edges; and squeezing together first and second arms secured to the blades to move the cutting edges through the toenail.

The method may further include a step of adjusting a depth of the cut by moving a transparent backstop adjacent to the hole.

The method may further include projecting light onto the blades by using a first light source onto the first blade.

The method may further include accessing a medicinal agent held by a reservoir in the second arm.

It is noted that not all the specific features described herein need to be incorporated in an arrangement for the arrangement to have some selected advantage according to the present disclosure.

### BRIEF DESCRIPTION OF THE DRAWINGS

FIG. 1 is a perspective view of an embodiment of a nail clipper, constructed in accordance with principles of this disclosure;

FIG. 2 is a perspective view of a portion of the nail clipper of FIG. 1, showing a step of energizing a light source;

FIG. 3 is a perspective view of the nail clipper of FIG. 1, showing a step of adjusting a backstop;

FIG. 4 is a side elevational view of the nail clipper of FIG. 1;

FIG. 5 is another perspective view of the grooming tool of FIG. 1, and showing a step of accessing a medicinal agent, constructed in accordance with principles of this disclosure; and

FIG. 6 is a perspective view of another perspective view of the nail clipper of FIG. 1.

The present technology may be more completely understood and appreciated in consideration of the following detailed description of various embodiments in connection with the accompanying drawings.

The figures are rendered primarily for clarity and, as a result, are not necessarily drawn to scale. Moreover, various structure/components, including but not limited to fasteners, and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

A pet nail clipper is shown in general at 20. The clipper 20 is used to cut or trim claws or toenails of animals, such as dogs and cats. As used herein, the term “nails”, or “toenails”, or “claws” are synonymous.

The clipper 20 includes a cutter 22 including a first blade 24 having a first v-shaped cutting edge 26. The cutter 22 also includes a second blade 28, opposed to the first blade 24, having a second v-shaped cutting edge 30. The first v-shaped cutting edge 26 and second v-shaped cutting edge 30 are positioned relative to each other to form a hole 32 to receive a nail for trimming. The hole 32 is diamond-shaped which provides for good stability on four sides for holding the nail to be trimmed.

The clipper 20 further includes a first arm 36 secured to the first blade 24; and a second arm 38 secured to the second blade 28. The first and second blades 24, 28 intersect and are movable connected together at joint 42. The first and second arms 36, 38 are sized for holding by a human hand. When the arms 36, 38 are squeezed toward each other, the cutting edges 26, 30 are moved toward each other, which will cut a nail positioned in the hole 32.

While many embodiments are possible, as shown herein, the first arm 36 has a handle section 86 and a blade holding section 88. The second arm 38 has a handle section 90, but not a blade holding section, although other embodiments could include a blade holding section for the second arm 38.

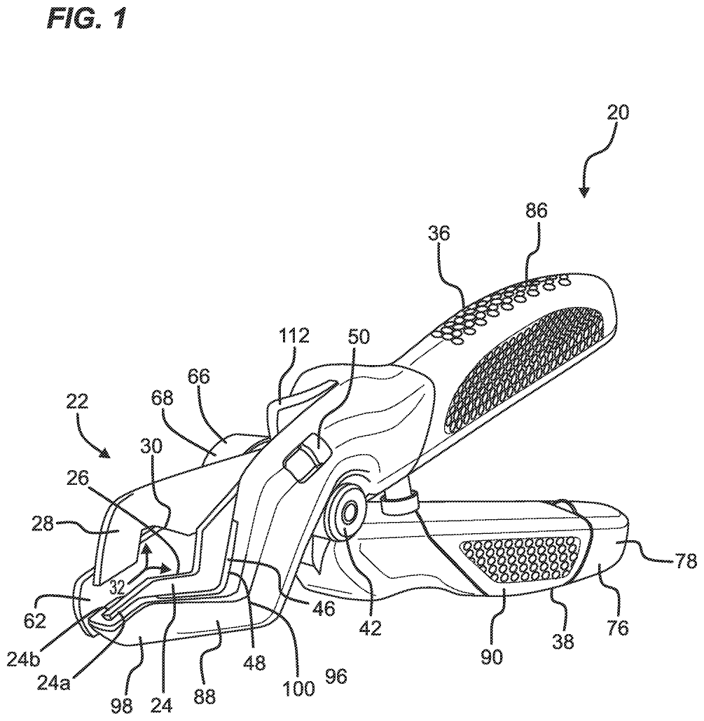

As can be seen in FIG. 1, the blade holding section 88 includes a pair of angled members 96, 98 forming generally an L-shaped chin 100 on opposite sides 24a, 24b of the first blade 24.

In accordance with principles of this disclosure, the clipper 20 further includes a light source positioned to project light onto the cutter 22. The light source includes at least a first light source 46 projecting light onto the first blade 24.

In the example embodiment shown, the first light source 46 is positioned to project light from the first arm 36 onto the first blade 24. In particular, while many embodiments are possible, in the one illustrated, the first light source 46 is an extended light pipe 48 positioned adjacent to the first blade 24.

As shown in FIG. 1, the light pipe 48 is secured to the chin 100 on opposite sides 24a, 24b of the first blade 24.

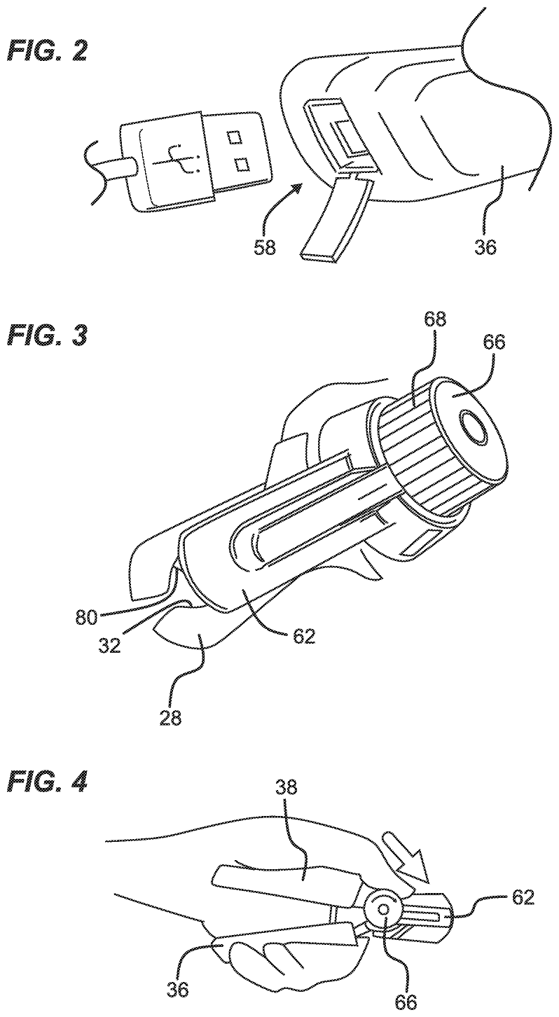

The light source 46 can be energized in a variety of ways. For example, it can be energized by a power source held within one of the first arm 36 or second arm 38, or both The power source can be a battery arrangement. Preferably, as shown in FIG. 2, the power source can be an electronic charge port 58 (FIG. 2). Many embodiments are possible.

The light source 46 is selectively turned on or off with a slidable light switch 50 located in the first arms 36 adjacent to the cutter 22.

In accordance with principles of this disclosure, a nail backstop 62 is provided. The backstop 62 is adjustably positioned relative to the cutter 22. In particular, the backstop 62 is movable axially inward or outward from the cutter 22, which allows for a selected depth for accommodating a nail 80 (FIG. 3) to be cut. Longer nails, or nails to be cut shorter, will have a greater depth as the axial distance between the backstop 62 and the cutter 22; while smaller nails, or nails to be cut longer, will have a more shallow depth as the axial distance between the backstop 62 and the cutter 22.

In preferred embodiments, the backstop 62 is transparent so that the nail to be cut will be visible through the backstop 62. The light pipe 48 is on both sides (outer facing 24a and inner facing 24b) of the first blade 24, which illuminates the second blade 28 and can be seen through the transparent backstop 62.

The backstop 62 can be made to be adjustable through a variety of ways. In the embodiment illustrated, there is a rotatable dial 66 secured to the second arm 38 and constructed and arranged to move the backstop 62 axially inward or outward. In this embodiment, the rotatable dial 66 has an outer knurled surface 68 for easy control.

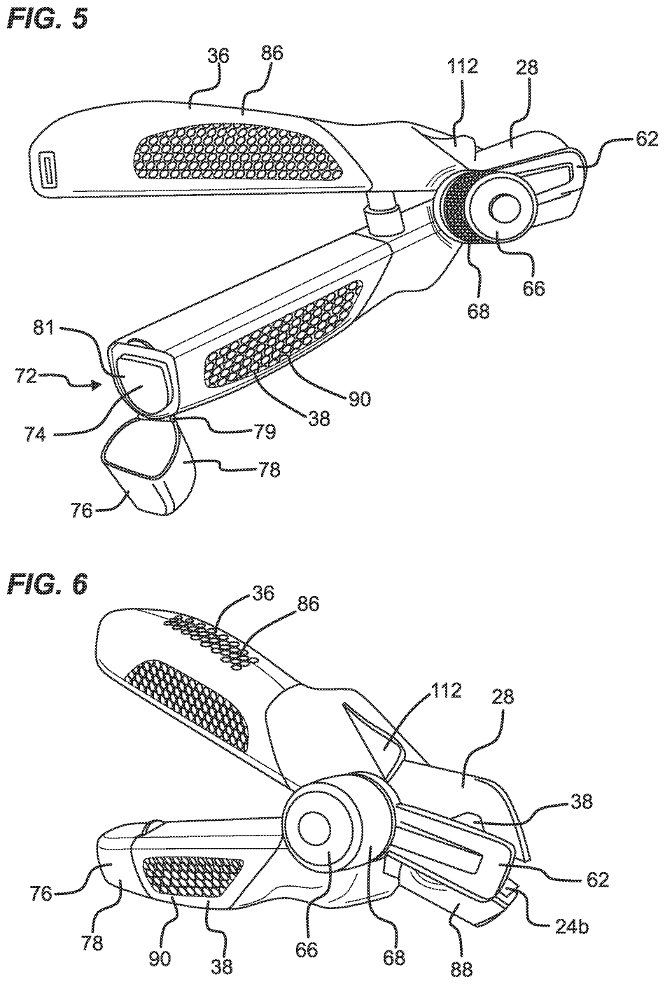

In accordance with principles of this disclosure, the clipper 20 further includes an on-board medicinal agent 72 (FIG. 5). The agent 72 can any of several different agents including, for example, a clotting agent. The clotting agent can be helpful if the nails 80 are cut too short and into the nail quick, leading to bleeding. The clotting agent can help stop the bleeding. Other medicinal agents can include, for example anti-fungal agents or dermatological agents.

In the example embodiment shown in FIG. 5, the second arm 38 includes a reservoir 74 holding the medicinal agent 72. In this example, the second arm 38 includes a movable cover 76 to expose the medicinal agent 72. The movable cover 76 can be completely removable from the second arm 38, or, as shown in the example embodiment, it can be a flip cap 78 pivotably attached along a hinge line 79 to a remaining part of the second arm 38.

In this example, the medicinal agent 72 is a gelatinous pad 81. When the pad 81 is used up, it can be replaced with a new gelatinous pad 81 of medicinal agent 72.

The clipper 20 also includes a blade lock 112 to selectively lock the cutter 22 in a closed position, and selectively unlock it to an open position. As shown in FIGS. 1, 5, and 6, the blade lock 112 is positioned within the first arm 36 adjacent to the cutter 22.

The above can be used in a method of trimming toenails of a pet. The method comprises positioning a toenail into hole 32 formed by opposing first and second blades 24, 28 having v-shaped cutting edges 26, 30. The method includes squeezing together first and second arms 36, 38 secured to the blades 24, 28 to move the cutting edges 26, 30 through the toenail.

The method can further including a step of adjusting a depth of the cut by moving backstop 62 adjacent to the hole 32. The backstop 62 is preferably transparent so that the nail 80 is visible from either side of the cutter 22.

The method can further include projecting light onto the blades 24, 28 by using a first light source 46 onto the first blade 24.

The method can further including accessing medicinal agent 72 held by a reservoir 74 in the second arm 38.

### Aspects:

Aspect 1. A pet nail clipper is provided comprising (a) a cutter including a first blade having a first v-shaped cutting edge; a second blade, opposed to the first blade, having a second v-shaped cutting edge; the first v-shaped cutting edge and second v-shaped cutting edge being positioned relative to each other to form a hole to receive a nail; (b) a first arm secured to the first blade; and (c) a second arm secured to the second blade.

Aspect 2. The nail clipper of aspect 1 further comprising a light source positioned to project light onto the cutter.

Aspect 3. The nail clipper of aspect 2 wherein the light source is positioned to project light from the first arm onto the cutter.

Aspect 4. The nail clipper of aspect 3 wherein the light source is an extended light pipe positioned adjacent to the first blade.

Aspect 5. The nail clipper of aspect 4 wherein:
(a) the first arm includes a handle section and a blade holding section; and
(b) the light pipe is secured to the blade holding section.

Aspect 6. The nail clipper of aspect 5 wherein:
(a) the blade holding section includes a pair of angled members forming a chin on opposite sides of the first blade; and
(b) the light pipe secured to the chin on the opposite sides of the first blade.

Aspect 7. The nail clipper of any one of aspects 2-6 wherein the light source is energized by an electronic charge port.

Aspect 8. The nail clipper of aspect 7 wherein the light source is energized by a power source held within one of the first arm or second arm.

Aspect 9. The nail clipper of any one of aspects 1-8 further including a transparent nail backstop adjustably positioned relative to the cutter.

Aspect 10. The nail clipper of aspect 9 further including a rotatable dial secured to one of the first arm or second arm and constructed and arranged to move the backstop axially inward or outward.

Aspect 11. The nail clipper of aspect 10 wherein the rotatable dial has an outer knurled surface.

Aspect 12. The nail clipper of any one of aspects 1-11 further including an on-board medicinal agent.

Aspect 13. The nail clipper of aspect 12 wherein the second arm includes a reservoir holding the medicinal agent.

Aspect 14. The nail clipper of aspect 13 wherein the second arm includes a movable cover to expose the medicinal agent.

Aspect 15. The nail clipper of aspect 14 wherein the movable cover is a flip cap pivotably attached to a remaining part of the second arm.

Aspect 16. The nail clipper of any one of aspects 13-15 wherein the medicinal agent is a clotting agent.

Aspect 17. The nail clipper of any one of aspects 13-16 wherein the medicinal agent is a gelatinous pad.

The nail clipper of any one of aspects 1-17, alone or in any combination, and/or with any component or subcomponent shown in the drawings.

Aspect 18. A method of trimming toenails of a pet is provided; the method comprising: (a) positioning a toenail into a hole formed by opposing first and second blades having v-shaped cutting edges; and (b) squeezing together first and second arms secured to the blades to move the cutting edges through the toenail.

Aspect 19. The method of aspect 18 further including a step of adjusting a depth of the cut by moving a transparent backstop adjacent to the hole.

Aspect 20. The method of any one of aspects 18 and 19 further including projecting light onto the blades by using a first light source onto the first blade.

Aspect 21. The method of any one of aspects 18-20 further including accessing a medicinal agent held by a reservoir in the second arm.

Aspect 22. The method of any one of aspects 18-21 using the nail clipper of any one of aspects 1-17/or any part or sub-component shown in the drawings.

The above describes example principles. Many embodiments can be made using these principles.

1. A pet nail clipper comprising:
(a) a cutter including a first blade having a first v-shaped cutting edge; a second blade, opposed to the first blade, having a second v-shaped cutting edge; the first v-shaped cutting edge and second v-shaped cutting edge being positioned relative to each other to form a hole to receive a nail;
(b) a first arm secured to the first blade; and
(c) a second arm secured to the second blade.

2. The nail clipper of claim 1 further comprising a light source positioned to project light onto the cutter.

3. The nail clipper of claim 2 wherein the light source is positioned to project light from the first arm onto the cutter.

4. The nail clipper of claim 3 wherein the light source is an extended light pipe positioned adjacent to the first blade.

5. The nail clipper of claim 4 wherein:
(a) the first arm includes a handle section and a blade holding section; and
(b) the light pipe is secured to the blade holding section.

6. The nail clipper of claim 5 wherein:
(a) the blade holding section includes a pair of angled members forming a chin on opposite sides of the first blade; and
(b) the light pipe secured to the chin on the opposite sides of the first blade.

7. The nail clipper of claim 2 wherein the light source is energized by an electronic charge port.

8. The nail clipper of claim 7 wherein the light source is energized by a power source held within one of the first arm or second arm.

9. The nail clipper of claim 1 further including a transparent nail backstop adjustably positioned relative to the cutter.

10. The nail clipper of claim 9 further including a rotatable dial secured to one of the first arm or second arm and constructed and arranged to move the backstop axially inward or outward.

11. The nail clipper of claim 10 wherein the rotatable dial has an outer knurled surface.

12. The nail clipper of claim 1 further including an on-board medicinal agent.

13. The nail clipper of claim 12 wherein the second arm includes a reservoir holding the medicinal agent.

14. The nail clipper of claim 13 wherein the second arm includes a movable cover to expose the medicinal agent.

15. The nail clipper of claim 14 wherein the movable cover is a flip cap pivotably attached to a remaining part of the second arm.

16. The nail clipper of claim 13 wherein the medicinal agent is a clotting agent.

17. The nail clipper of claim 13 wherein the medicinal agent is a gelatinous pad.

18. A method of trimming toenails of a pet; the method comprising:
(a) positioning a toenail into a hole formed by opposing first and second blades having v-shaped cutting edges; and
(b) squeezing together first and second arms secured to the blades to move the cutting edges through the toenail.

19. The method of claim 18 further including a step of adjusting a depth of the cut by moving a transparent backstop adjacent to the hole.

20. The method of claim 18 further including projecting light onto the blades by using a first light source onto the first blade.

21. The method of claim 18 further including accessing a medicinal agent held by a reservoir in the second arm.

22. (canceled)
